(19) United States
(12) Patent Application Publication
(10) Pub. No.: US 2018/0252890 A1
(43) Pub. Date: Sep. 6, 2018

(54) GUIDE SYSTEM

(71) Applicant: Carl Zeiss Sports Optics GmbH, Wetzlar (DE)

(72) Inventors: Christoph Schmitt, Biebertal (DE); Armin Schlierbach, Leun-Bissenberg (DE)

(21) Appl. No.: 15/909,871

(22) Filed: Mar. 1, 2018

(30) Foreign Application Priority Data
Mar. 1, 2017 (DE) 102017104299.7

(51) Int. Cl. G02B 7/04; G02B 23/00; G02B 7/06

(52) U.S. Cl. CPC G02B 7/04; G02B 7/06; G02B 23/00

(57) ABSTRACT

The invention relates to a guide system, in particular for guiding the linear focusing of an optical device such as binoculars or a telescopic sight. The guide system here includes a guide body and a slide member which is mounted displaceably relative to the guide body along a guide axis. A bearing element is provided for the displaceable mounting of the slide member along the guide axis. The bearing element is configured here to reduce a radial play, extending radially with respect to the guide axis, between the slide member and the guide body.

### CROSS REFERENCE TO RELATED APPLICATION

This application claims priority of German patent application no. 10 2017 104 299.7, filed Mar. 1, 2017, the entire content of which is incorporated herein by reference.

### FIELD OF THE INVENTION

The invention relates to a guide system, in particular for guiding the linear focusing of an optical device.

### BACKGROUND OF THE INVENTION

In optical devices with focusing adjustment, an object is brought into focus by varying the distances between optical elements of the device, in order to influence the beam path. A user can often use a control element in order to effect a rotation movement, which is converted into a displacement of a focusing member, hereinafter also referred to as slide member. Such a slide member can, for example, hold a lens or a group of lenses, which can accordingly be displaced along the optical axis.

While the slide member is displaceable along the optical axis, degrees of freedom radially with respect to the optical axis are generally undesired. It is instead desirable for the slide member to be guided free of play along the focusing axis. For this purpose, those radial tolerances that remain in order to ensure smooth longitudinal mobility are often compensated.

For example, there are binoculars in which the play in the guide is compensated by a metal spring. However, this is often associated with the disadvantage of having to introduce elaborate countersinks into the mounts. Moreover, the metal of a spring subjects the housing to relatively strong stresses, which can also become noticeable in the form of abrasion or wear.

U.S. Pat. No. 8,950,101 discloses a telescopic sight including an outer tube and an inner tube arranged in the latter, wherein the inner tube has an optical inversion system with at least two optical elements which are held in mounts and which are mounted movably in the direction of the longitudinal axis of the telescopic sight, wherein the magnification can be modified by the movement of the lenses, wherein the mounts are pretensioned inside a guide sleeve by an elastic means. In one embodiment, provision is made that the elastic means are made of plastic, but here too the elastic means are introduced into recesses. The way in which the mounts are guided in the guide sleeve is also open to improvement in terms of the smooth running and resistance to friction.

Thus, a much more difficult movement of the slide member can arise if, for example, the play between the mount and the guide sleeve is shifted to one side by springs, magnets or elastomers.

### SUMMARY OF THE INVENTION

It is an object of the invention to provide a guide system which permits guiding free of play along a guide axis, particularly in order to guide an optical assembly free of play along an optical axis.

One aspect of the object of the invention is to provide a guide system which runs particularly smoothly and with little friction and is at the same time cost-effective, wherein it is possible in particular to do without countersinks or recesses and wherein relatively large tolerances can be compensated.

A further aspect of the object of the invention is to permit reliable guiding even when the relationships between the diameter and the length of a slide member are unfavorable, particularly in order to prevent what is called a stick-slip effect or “rattling”.

The object can, for example, be achieved via a guide system including: a guide body defining a guide axis; a slide member mounted displaceably along the guide axis relative to the guide body; a bearing element having a bearing surface for the displaceable mounting of the slide member in such a way that the bearing surface comes into gliding contact with an associated abutment surface when the slide member is displaced along the guide axis; the bearing element being arranged between the slide member and the guide body in such a way that the bearing element reduces a radial play extending radially with respect to the guide axis between the slide member and the guide body; and, the bearing element having an interference fit for the radial play and a resilience in the radial direction for compensation of the interference fit.

The object can, for example, further be achieved by a guide system, in particular for guiding the linear focusing of an optical device, the guide system including a guide body defining a guide axis; a slide member mounted displaceably along the guide axis relative to the guide body; a bearing element including at least one roller bearing with a roller body, in such a way that the roller body is in contact with the slide member and the guide body; the roller body being configured to roll on the slide member and the guide body when the slide member is displaced along the guide axis; and, the bearing element being arranged between the slide member and the guide body in such a way that the bearing element reduces a radial play, extending radially with respect to the guide axis, between the slide member and the guide body.

The object can, for example, further be achieved by a slide member for a guide system having a guide body defining a guide axis, the slide member including: a slide member body; a bearing element secured on the slide member body and having a bearing surface for the displaceable mounting of the slide member along a guide axis; the bearing element including a resilient, elastic component in order to provide a resilience to the bearing element; the bearing element including a glide component which forms the bearing surface of the bearing element; and, the glide component of the bearing element having a lower coefficient of friction and a lower compressibility than the resilient component of the bearing element.

The object can, for example, further be achieved by a slide member for a guide system having a guide body defining a guide axis, a bearing element including at least one roller bearing with a roller body in such a way that the roller body is in contact with the slide member and the guide body, the roller body being configured to roll on the slide member and the guide body when the slide member is displaced along the guide axis, and the bearing element being arranged between the slide member and the guide body in such a way that the bearing element reduces a radial play, extending radially with respect to the guide axis, between the slide member and the guide body, the slide member including: a slide member body having a jacket surface; and, the jacket surface having at least one elongate recess which runs parallel to the guide axis and is configured to receive the bearing element.

The invention relates to a guide system, in particular for guiding the linear focusing of an optical device, with a guide body which defines a guide axis, and with a slide member which is mounted displaceably along the guide axis relative to the guide body. The slide member, within the meaning of the invention, can include a focusing lens that can be used to focus an object onto an intermediate image plane.

Extending radially with respect to the guide axis, between the slide member and the guide body, there is a preferably slight radial play, which in particular ensures the displaceability of the slide member.

Moreover, a bearing is included which is arranged between the slide member and the guide body in such a way that the bearing element reduces the radial play between the slide member and the guide body. The radial play is preferably compensated or bridged.

According to a first embodiment, the bearing element, preferably secured on the slide member, has a bearing surface for the displaceable mounting of the slide member, in such a way that the bearing surface is in gliding contact with an associated abutment surface, preferably formed on the guide body, when the slide member is displaced along the guide axis.

The bearing element has, on the one hand, an interference fit with respect to the radial play and, on the other hand, it has a resilience in the radial direction for compensation of the interference fit.

The bearing element is accordingly compressible and, in the inserted state, yields in such a way that the radial play is bridged with precision. Preferably, the bearing element is also elastic, such that the bearing surface exerts a pressing force on the associated abutment surface. In this way, tolerances of the radial play, in particular along the guide axis, can be compensated during displacement.

The securing of the bearing element means that the bearing element is secure against slipping when the slide member is moved. The securing of the bearing element can in particular be effected without a recess. For example, the bearing element can be adhesively affixed to the slide member. The production costs can be reduced in this way.

The bearing element does not necessarily have to be secured on the slide member. Alternatively, the bearing element can also be secured on the guide body. The associated abutment surface can in this case be formed on the slide member.

The bearing element preferably includes a resilient, in particular elastic component in order to provide the resilience of the bearing element, and a glide component which forms the bearing surface of the bearing element. The bearing element accordingly includes at least two different components with different materials.

The resilient component of the bearing element has a greater compressibility that the glide component.

To this end, the glide component has a lower coefficient of friction than the resilient component. The bearing element is thus advantageously characterized by a high degree of compressibility while at the same time having excellent glide performance.

The resilient component of the bearing element can in particular be made of foam, while the glide component preferably includes polytetrafluoroethylene (PTFE). PTFE has the advantage that static friction and kinetic friction are equal, with the result that “rattling” can be prevented. However, other materials can be provided, particularly those with low coefficients of friction. For example, polyoxymethylene (POM), polyetheretherketone (PEEK) and/or polyvinylidene fluoride (PVDF) can also be included.

The bearing element can in particular be made of several layers, wherein the uppermost layer forms the glide component, and a layer located below this forms the resilient component. Moreover, further layers can be provided, for example in particular an intermediate layer which connects the glide layer to the resilient layer. A connection component can accordingly be provided, for example, of polyethylene (PE) and/or polyethyleneterephthalate (PTFE), and connects the glide component to the resilient component.

In an embodiment of the invention, the guide body is configured as a sleeve, in particular as a tubular sleeve. Generally speaking, the guide body can accordingly radially surround the slide member in such a way that an inner surface of the guide body is directed toward an outer surface of the slide member. The bearing element can then be secured on the outer surface of the slide member, and the inner surface of the guide body can include the abutment surface. However, the reverse configuration is also possible, in which the bearing element is secured on the inner surface of the guide body and the abutment surface is formed on the slide member.

In principle, the radial play between the slide member and the guide body does not have to extend all the way round the slide member. In an embodiment of the invention, however, provision is made that the radial play, extending radially with respect to the guide axis, between the slide member and the guide body also extends tangentially over the entire circumference, in such a way that the slide member is spaced apart from the guide element all the way round, radially with respect to the guide axis. It is then possible to provide a plurality of bearing elements.

In addition to the bearing element, it is possible in particular to provide a second and a third bearing element which in turn each include a bearing surface for the displaceable mounting of the slide member, in such a way that the bearing surfaces of the second and third bearing elements are each in gliding contact with an associated abutment surface when the slide member is displaced along the guide axis.

A bearing element is preferably considerably smaller than the outer surface of the slide member, in order to minimize friction. Provision can be made that a bearing element extends tangentially to the guide axis about an angle of less than 45 degrees, preferably of less than 20 degrees, particularly preferably of less than 10 degrees. Moreover, a bearing element is in particular configured, for example, as a round disk and, along the guide axis, also has an extent that is less than the length of the slide member. Both the bearing element and also the second and third bearing element can thus be configured as wafers.

The second and third bearing elements are also each preferably secured on the slide member, and the guide body includes the respective abutment surface, in such a way that the bearing surfaces of the second and third bearing elements secured on the slide member glide along the respective abutment surfaces of the guide body when the slide member is displaced along the guide axis. Once again, the reverse configuration is also possible in principle.

Provision is preferably made that the (first) bearing element has greater resilience than the second and/or third bearing element. Instead, these have in particular a negligible resilience.

In other words, preferably one of the bearing elements, particularly preferably only one of the bearing elements of a group of three or more bearing elements, is intended to compensate the radial play in a resilient manner, wherein a group of bearing elements can be arranged in such a way that the slide member is spaced apart from the guide body all the way round.

Provision can be made that the bearing element, the second bearing element and the third bearing element are spaced apart from each other in a direction tangential to the guide axis and are distributed in total about a circumferential portion of over 180 degrees, preferably over 200 degrees, particularly preferably approximately 2×120=240 degrees, in particular in order to form a three-point bearing.

The bearing element, the second bearing element and the third bearing element preferably form a group which can be arranged in a plane perpendicular to the guide axis. It is possible to include further groups which are offset along the guide axis in order to prevent tilting of the slide member.

A fourth bearing element, preferably also a fifth bearing element, very particularly preferably also a sixth bearing element can be included, wherein these bearing elements are each spaced apart from the bearing element, the second bearing element and/or the third bearing element along the guide axis.

The slide member preferably includes a force application site arranged eccentrically with respect to the guide axis, for subjecting the slide to a sliding movement. The force application site can be connected, for example, to a guide rod in order to displace the slide member along the guide axis.

The force application site of the slide member, in the tangential direction to the guide axis, is in particular arranged farther from the bearing element than it is from the second and/or third bearing element. The resilient bearing element can be arranged, for example, opposite the force application site. Via this arrangement, the second and third bearing elements, which are in particular harder or non-resilient, behave in the manner of a rail and form a flat triangle of forces with the point where force is introduced. This also makes it possible in particular to reliably displace slide members which have a large radial extent and a small longitudinal extent.

The invention also relates to a slide member, in particular for a guide system for the linear focusing of an optical device, including a bearing element which is secured on the slide member and which has a bearing surface for the displaceable mounting of the slide member along a guide axis.

The bearing element in turn includes a resilient, in particular elastic component in order to provide the resilience of the bearing element, and a glide component which forms the bearing surface of the bearing element, wherein the glide component of the bearing element has a lower coefficient of friction and less compressibility than the resilient component of the bearing element.

The resilient component of the bearing element preferably includes foam, while the glide component of the bearing element includes polytetrafluoroethylene (PTFE).

A second and a third bearing element are preferably secured on the slide member and each include a bearing surface for the displaceable mounting of the slide member along the guide axis, and the (first) bearing element has greater resilience than the second and/or third bearing element, which in particular have substantially no resilience.

The bearing element, the second bearing element and the third bearing element are in turn preferably secured on the slide member in a manner spaced apart from each other in a direction tangential to the guide axis and are distributed about a circumferential portion of over 180 degrees, in particular in order to form a three-point bearing.

A fourth bearing element, preferably also a fifth bearing element, very particularly preferably also a sixth bearing element can be included which are each secured on the slide member in a manner spaced apart from the (first) bearing element, the second bearing element and/or the third bearing element along the guide axis.

The slide member can include a force application site arranged eccentrically with respect to the guide axis, for subjecting the slide member to a sliding movement, wherein the force application site, in particular in the tangential direction to the guide axis, is arranged farther from the first bearing element than it is from the second and/or third bearing element.

According to a further embodiment of the guide system, at least one bearing element is configured as a roller bearing. A great advantage over a bearing element configured as a plain bearing lies in the considerably lower friction that arises between the components in question, that is, the slide member and the guide body, during an axial relative movement. In a roller bearing, in contrast to a plain bearing, there is substantially only rolling friction.

The radial play between guide body and slide member can be minimized in this way. Embodiments are also possible in which there is no radial play, and instead a slight interference is provided.

To permit displaceability of the slide member along the guide axis relative to the guide body, it is recommended to use balls as roller bodies.

Therefore, at least one bearing element according to this embodiment is advantageously configured as a ball bearing. Such a bearing element can include one ball, but preferably more than one ball. In an advantageous embodiment, a bearing element includes an arrangement with a number of balls ranging from two to ten, a particularly suitable embodiment having five balls.

In addition to the bearing element, it is possible in particular to include a second and a third bearing element which in turn are each configured as roller bearings, preferably as ball bearings, in such a way that an axial displaceability of the slide member along the guide axis is permitted.

In the embodiment with roller bearings as the bearing element, provision can also be made that the bearing element, the second bearing element and the third bearing element are spaced apart from each other in a direction tangential to the guide axis and are distributed in total about a circumferential portion of over 180 degrees, preferably over 200 degrees, particularly preferably approximately 2×120=240 degrees, in particular in order to form a three-point bearing.

The bearing element, the second bearing element and the third bearing element preferably form a group which can be arranged in a plane perpendicular to the guide axis. It is likewise possible to include further groups which are offset along the guide axis in order to prevent tilting of the slide member.

A fourth bearing element, preferably also a fifth bearing element, very particularly preferably also a sixth bearing element can be included, wherein these bearing elements are each spaced apart from the bearing element, the second bearing element and/or the third bearing element along the guide axis.

To receive the at least one roller bearing, the slide member can be configured with a recess on its jacket surface for partially receiving the roller body of the bearing element. In the case of balls as roller bodies, particularly in the case of more than one ball, the recess can be configured in the form of a longitudinal groove. In the case of balls as roller bodies, a longitudinal groove formed on the jacket surface of the slide member and parallel to the guide axis makes it possible to receive more than one ball. The balls are accordingly arranged parallel to the guide axis.

Thus, in a particularly preferred embodiment, several balls, for example five balls, which can be held with a chain or with a cage, can be inserted into a longitudinal groove of suitably dimensioned length. The longitudinal groove can be V-shaped and have an acute angle, in the direction of the guide axis, of between 70° and 110°, preferably between 80° and 100°, particularly preferably between 85° and 95°. A ball inserted in the longitudinal groove can thus form two contact regions with the two mutually opposite side faces of the longitudinal groove.

The depth of the recess is adapted to the size of the roller bodies that are to be received. Roller bodies inserted into the recess preferably protrude radially past the jacket surface of the slide member, such that a contact between an inserted roller body and a surrounding guide body is permitted when the slide member is introduced into the guide body. The inner surface of the guide body accordingly forms the abutment surface of the roller body and allows the latter to roll during axial displacement of the slide member relative to the guide body.

The bearing element with roller body does not necessarily have to be inserted into the recess on the slide member. Alternatively, the bearing element can also be arranged on the guide body. For this purpose, the guide body is to be provided with corresponding recesses in order to receive the roller body, whereas the jacket surface of the slide element forms the associated abutment surface. Embodiments are also conceivable in which portions of guide body and slide member lying opposite each other in the mounted position are formed with recesses for receiving the roller body. However, the production costs are then higher, since two components have to be worked in each case.

To provide the slide member and the guide body with an axial displaceability that is free of play, the bearing element is preferably dimensioned in such a way that it has a slight interference with respect to the radial play. The interference of the bearing can be in a range from several μm up to 100 μm or even more. An interference of the bearing of approximately 5 μm up to 120 μm is advantageous. Finally, the interference of the bearing is to be chosen in such a way that, in the mounted position, an axial displacement of the slide member in the guide body is possible, while at the same time there is as far as possible no play between slide member and bearing element and the guide body.

In the case of three bearing elements which can be arranged in a plane perpendicular to the guide axis, it is recommended to distribute these uniformly about the circumference. There is then an angle of 120° between two respective longitudinal grooves.

The invention also relates to an optical device, in particular binoculars, with a guide system and/or a slide member, wherein the slide member is configured as a focusing member and in particular as a lens mount.

Below, the invention is explained in more detail on the basis of illustrative embodiments and with reference to the figures, wherein equivalent and similar elements are partly provided with the same reference signs and the features of the various illustrative embodiments can be combined with one another.

### BRIEF DESCRIPTION OF THE DRAWINGS

The invention will now be described with reference to the drawings wherein:

FIG. 1A shows a front view of a slide member, arranged inside a guide body, FIG. 1B shows a detail in the region of a bearing element, and FIG. 1C shows a detail in the region of a second/third bearing element;

FIG. 2 shows a perspective view of the slide member from FIGS. 1A to 1C;

FIG. 3A shows a side view directed to the bearing element, FIG. 3B shows a front view, FIG. 3C shows a side view directed to the force application site, and FIG. 3D shows a rear view of the slide member from FIG. 2;

FIG. 4 shows a perspective view and a side view of the bearing element;

FIG. 5 shows a perspective view and a side view of the second/third bearing element;

FIG. 6 shows a perspective view of a further embodiment of a slide member;

FIG. 7A shows a side view directed to the bearing element, FIG. 7B shows a front view, FIG. 7C shows a side view directed to the force application site, and FIG. 7D shows a rear view of the slide member from FIG. 6;

FIG. 8 shows a sectional view of a slide member arranged inside a guide body of a further embodiment with three bearing elements configured as roller bearings;

FIG. 9 shows a schematic view of binoculars; and,

FIG. 10 shows a schematic view of a telescopic sight.

### DESCRIPTION OF THE PREFERRED EMBODIMENTS OF THE INVENTION

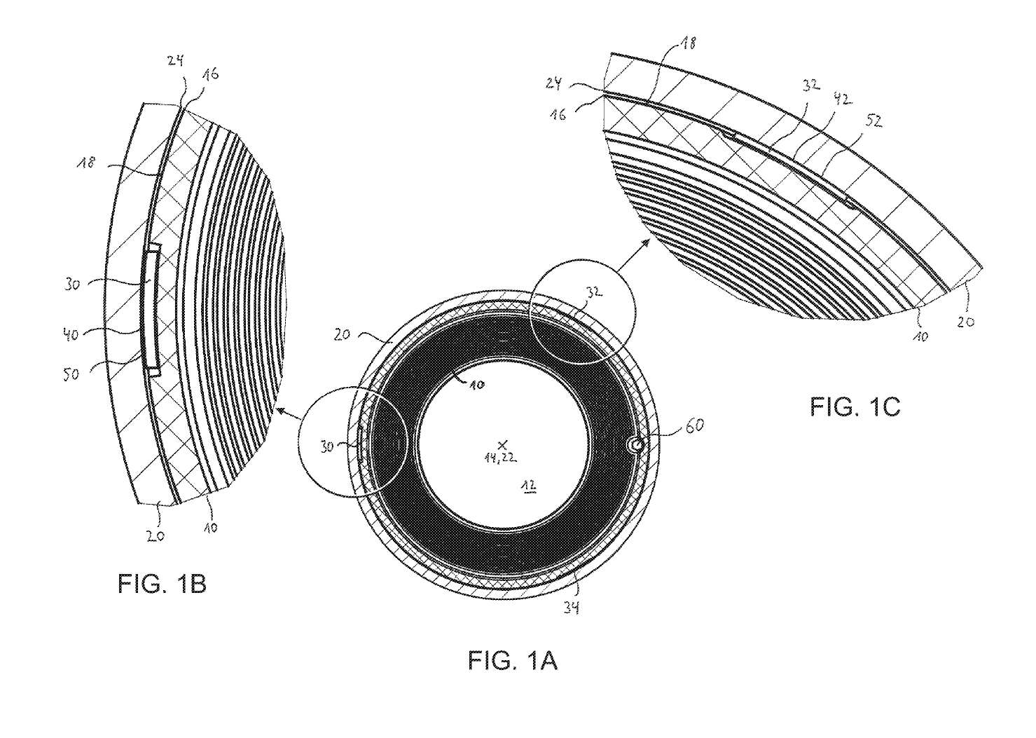

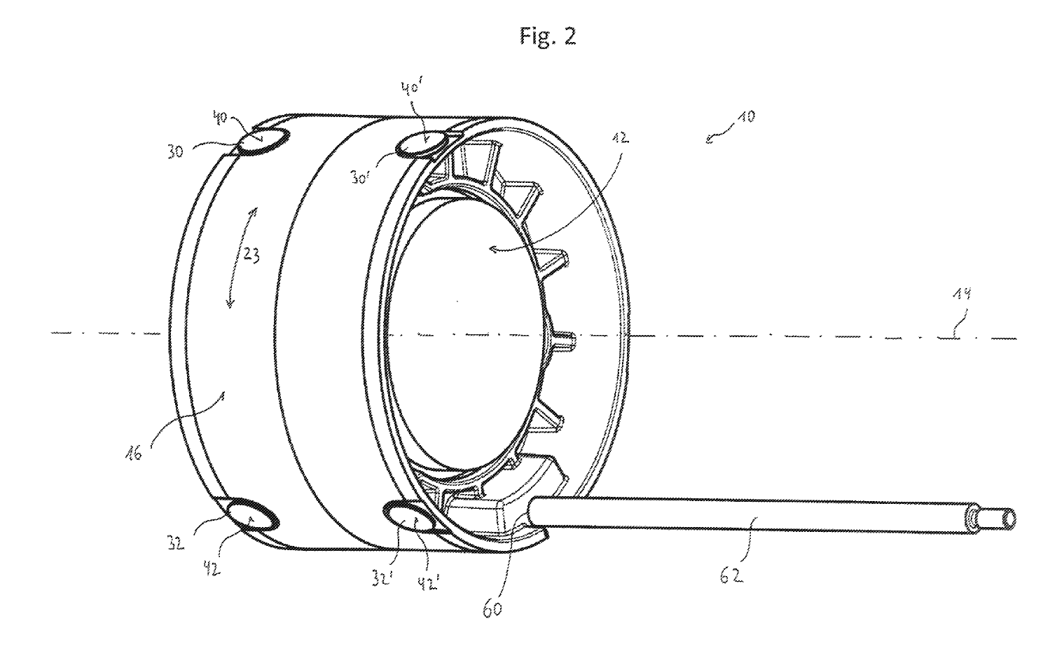

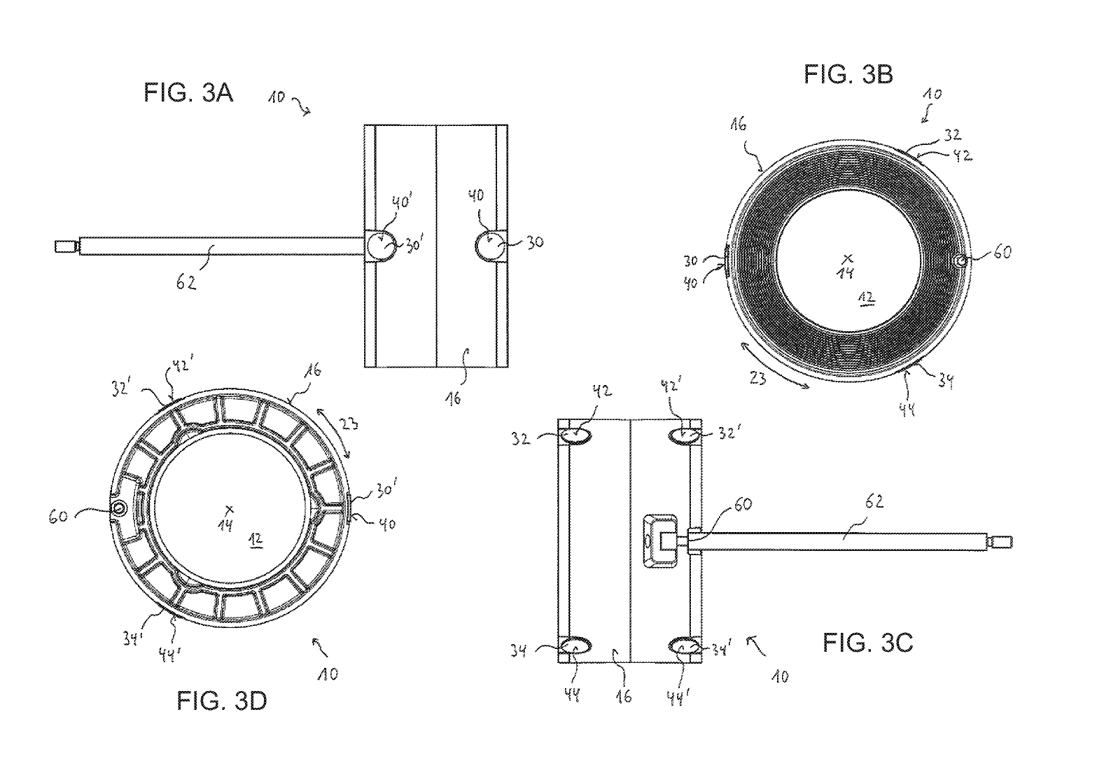

Referring to FIGS. 1A to 3D, an annular slide member 10 according to a first embodiment has a central opening 12 with a mount for receiving an optical component, for example a lens. The slide member 10 thus defines an optical axis 14 along which it can be displaced. The slide member 10 is guided in a guide body 20 configured as a guide sleeve, wherein the guide body 20 defines a guide axis 22 running parallel to the optical axis 14.

The inner surface 24 of the tubular guide body 20 is directed toward an outer surface 16 of the slide member 10, wherein a radial play 18 remains between the inner surface 24 of the guide body 20 and the outer surface 16 of the slide member 10 and ensures the displaceability.

The radial play 18 is compensated by bearing elements 30, 32, 34, 30′, 32′, 34′, which are configured as glide pads and are secured, for example, adhesively bonded, to the outer surface 16 of the slide member 10. The bearing elements 30, 32, 34, 30′, 32′, 34′ are self-adhesive on one side and have, on the other side, respective bearing surfaces 40, 42, 44, 40′, 42′, 44′ which are configured as a smooth glide surface and which are directed toward the inner surface 24 of the guide body 20. The inner surfaces 24 each form associated abutment surfaces 50, 52 for gliding contact during displacement of the slide member 10. In order to improve the glide properties, provision can be made that the guide body 20, its inner surface 24 or at least the abutment surfaces 50, 52 are coated with an anti-friction coating in order to achieve a smoother surface. An anti-friction varnish can be used for this purpose.

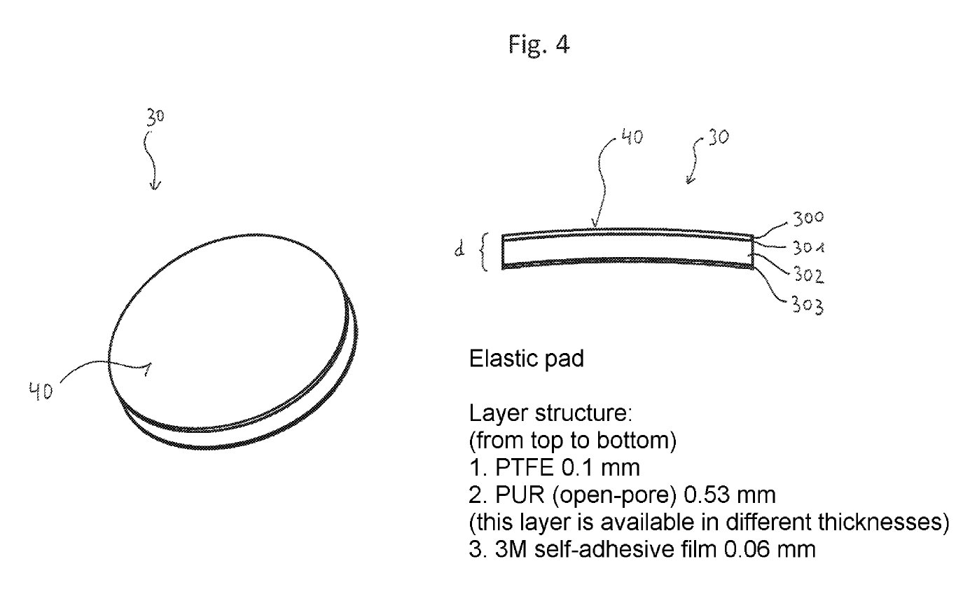

FIG. 4 shows an example of the multi-layered structure of the bearing element 30, wherein the bearing element 30′ in the example shown is of identical configuration. The bearing elements 30, 30′ have an interference fit for the radial play 18 that is to be bridged, that is, the distance between the slide member 10 and the guide body 20. However, the bearing elements 30, 30′ are at the same time resilient, such that the interference fit is compensated when the slide member 10 is in contact with the guide body 20. In other words, the bearing elements 30, 30′ are compressed and the slide member 10 is held in position.

The interference is in a range of 0.01 mm to 0.7 mm, preferably in a range of 0.03 mm to 0.5 mm. In the case shown as an example, the interference is 0.1 mm.

The bearing elements 30, 30′ have a thickness d which, in the non-compressed state, is in the range of 0.1 mm to 3.2 mm, preferably in the range of 0.2 mm to 1.6 mm, particularly in the range of 0.3 mm to 1.2 mm. A thickness can more preferably be in the range of 0.5 mm to 1.0 mm. In the example shown, a thickness of 0.69 mm is provided. In this example, the bearing elements 30, 30′ have a glide component 300 which is configured as a PTFE layer and which forms the respective bearing surfaces 40, 40′. Moreover, the bearing elements 30, 30′ have a resilient component 302 configured in this example as a layer of PU foam. In this example, these two layers or components are connected to each other by a connection component 301 configured as a PE(T) intermediate layer. In this example, an adhesive component 303 configured as a self-adhesive film is applied to the side of the resilient component directed away from the glide component. The bearing elements 30, 30′ are affixed to the slide member 10 by the adhesive component 303.

In other words, the bearing element 30 (and 30′) has a resilient component 302 which is configured as a foam core and which is easily fitted with pretensioning and thus presses the assembly free of play. The elastic component can be produced from polyurethane (PUR), in particular as an open-pore polyurethane foam, for example, in the form of a polyurethane mat.

The glide component 300 can have a thickness in the range of 0.01 mm to 2 mm, preferably in the range of 0.02 mm to 1 mm, particularly preferably in the range of 0.03 mm to 0.3 mm. In the example shown, a PTFE layer with a thickness of 0.1 mm is provided. However, the glide component can also be configured as a lubricating varnish.

The resilient component 302 can have a thickness in the range of 0.1 mm to 3.0 mm, preferably in the range of 0.2 mm to 2.0 mm, particularly preferably in the range of 0.3 mm to 1.0 mm. A thickness can more preferably be in the range of 0.4 mm to 0.8 mm. In the example shown, a PUR layer with a thickness of 0.53 mm is provided.

The resilient component 302 preferably has a lower density than the glide component 300. In particular, the resilient component 302 can have a density in the range of 5 pcf to 50 pcf (pounds per cubic foot), preferably in the range of 8 pcf to 35 pcf, particularly preferably in the range of 10 pcf to 30 pcf. A density can more preferably be in the range of 20 pcf to 30 pcf. In the example shown, the PUR layer has a density of 25 pcf.

By choosing the density of the resilient component and also the surface area of the bearing element, it is advantageously possible to adjust the force that is exerted in the installed state. In this way, the bearing can be precisely tared, particularly with respect to the dimensions and/or the materials of the guide system. A further advantage is the possibility of compensation of manufacturing tolerances, for example by choosing bearing elements with a defined density and/or a defined thickness depending on the radial play.

The adhesive component 303 can have, for example, a thickness in the range of 0.01 mm to 0.3 mm, preferably in the range of 0.02 mm to 0.15 mm. In the example shown, a self-adhesive film with a thickness of 0.06 mm is provided.

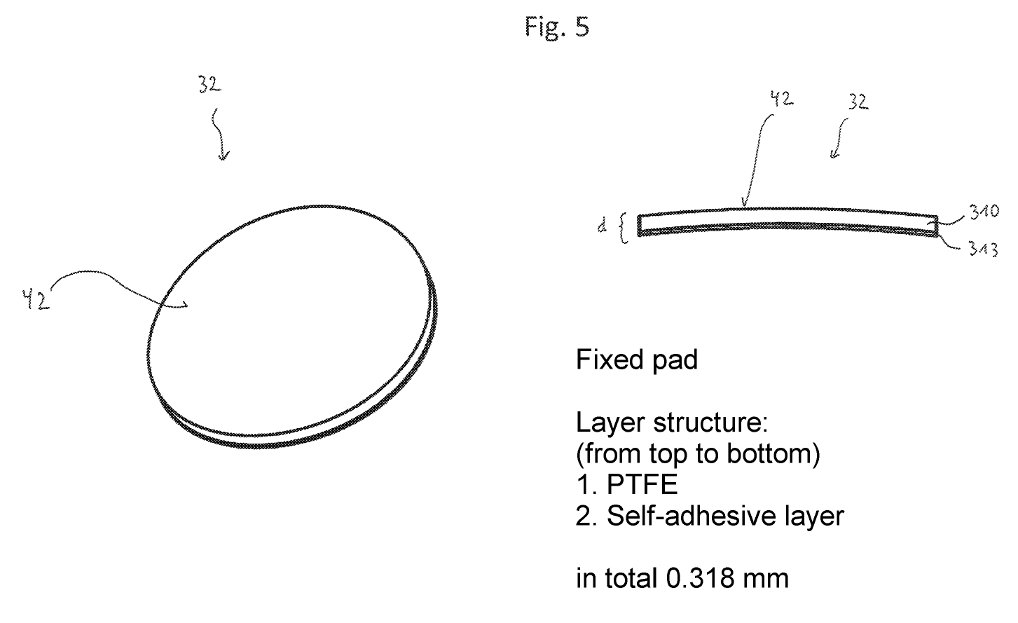

FIG. 5 shows an example of the bearing element 32, wherein the bearing elements 34 and also 32′ and 34′ in the example shown are of identical configuration. Compared to the bearing elements 30, 30′, the bearing elements 32, 34, 32′, 34′ are configured as substantially fixed glide pads. They have a glide component 310 configured as a layer of PTFE and, connected to the latter and configured as a self-adhesive film, an adhesive component 313 with which they are affixed to the slide member 10. The thickness d of the bearing elements 32, 34, 32′, 34′ is preferably 0.1 mm to 1 mm, particularly preferably 0.2 mm to 0.6 mm and very particularly preferably 0.25 mm to 0.5 mm. A thickness of 0.318 mm is provided in the example shown.

Particularly when viewed along a tangential direction 23, the fixed bearing elements 32, 34 (and 32′, 34′) are arranged closer to an eccentrically positioned force application site 60 than is the resilient bearing element 30 (and 30′). In this way, particularly reliable guiding of the slide member 10 along the guide axis 22 is achieved.

The force application site 60, which is here configured as a seat for a focusing rod 62, serves to transmit a sliding movement to the slide member 10. During transmission of a sliding force, the fixed bearing elements 32, 34 and 32′, 34′ provide stable guiding, without the slide member 30 tending to tilt. The fixed bearing elements 30 form as it were a stable rail against which the slide member is pressed by the resilient bearing elements. This ensures safe guiding during the displacement.

The force application site 60 can in particular be configured as an oblong hole, wherein the focusing rod 62 engages in the oblong hole in a manner free of axial play.

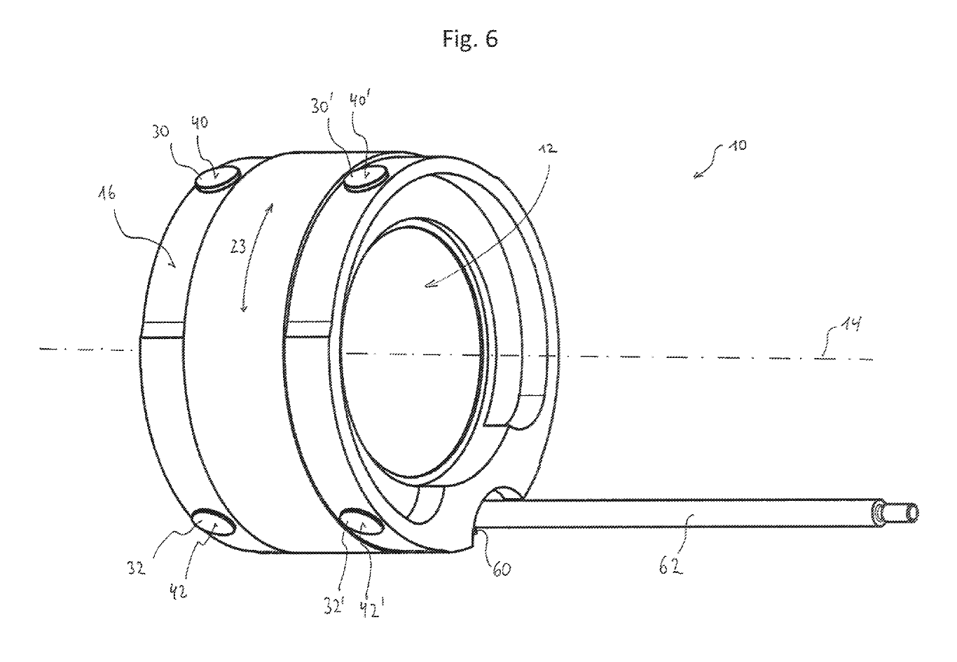

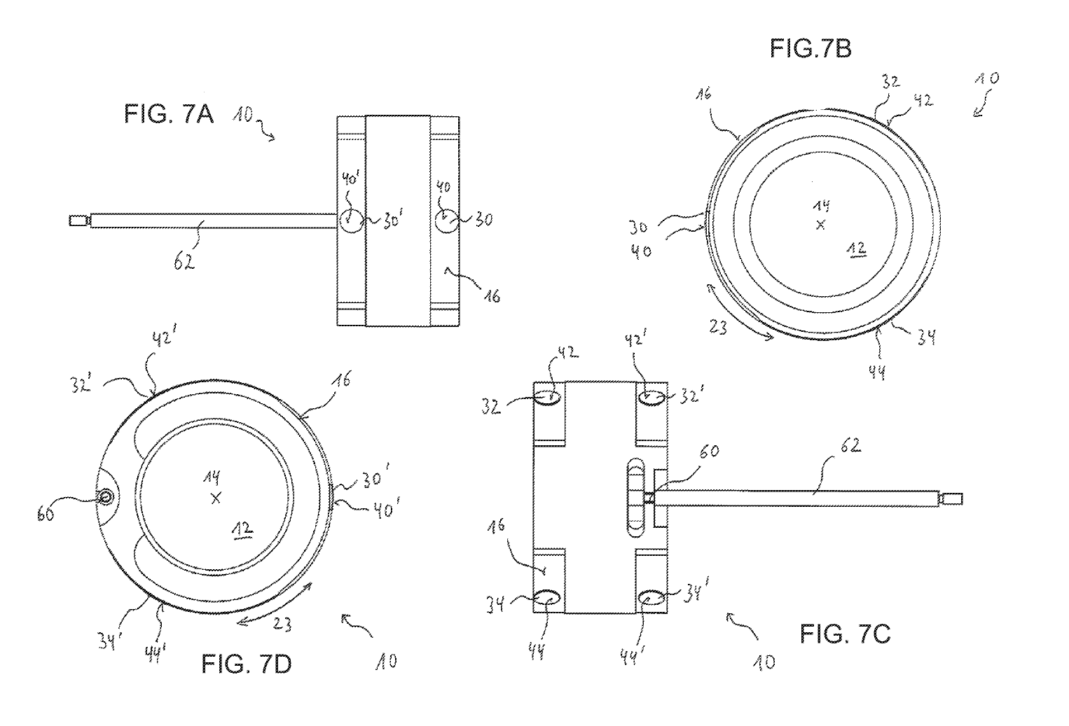

The embodiment of the slide member 10 shown in FIGS. 1A to 3D is configured as a plastic injection molding. However, the slide member 10 may be made not just of plastic, and numerous other materials may instead also be taken into consideration. In particular, the slide member 10 can be made from light metal, for example from magnesium and/or aluminum. An embodiment of a slide member 10 made of light metal is shown in FIG. 6 and FIGS. 7A to 7D.

It may be preferable to avoid lubrication of the guide system, since lubrication can cause undesirable optical flares. On the other hand, particularly when the ratios of the diameter and length of the slide member are unfavorable, and also depending on the materials used, the slide member may sometimes tilt when starting off or when the load changes.

To avoid such tilting moments, lubrication may be expedient, for example, with a Teflon grease. In order to avoid optical flares, it is possible to use a light-absorbing or light-filtering lubricant which, for example, can include black pigments and/or carbon nanotubes.

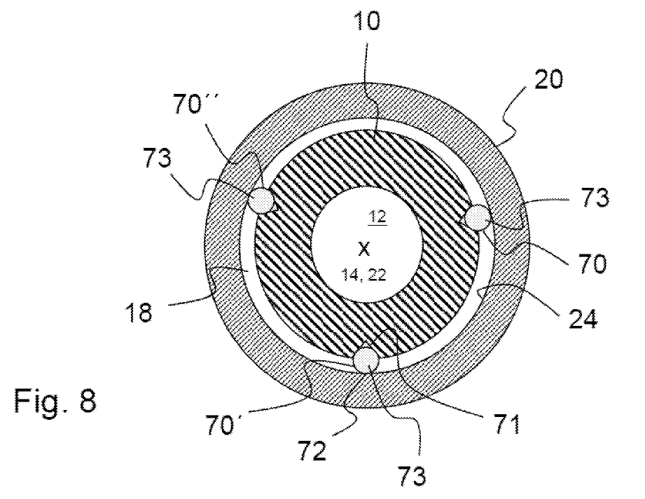

FIG. 8 finally shows a sectional view of a slide member 10, configured as a slide member, arranged inside a guide body 20 according to a further embodiment.

According to this further embodiment of the guide system, at least one bearing element 70 is configured as a roller bearing. The configuration of the at least one bearing element 70 as a roller bearing affords the advantage of much less friction between the slide member 10 and the guide body 20 during an axial movement relative to each other, since the contact regions between bearing element 70 and slide member 10/guide body 20 are much smaller, and there is substantially only a rolling friction during displacement.

To permit displaceability of the slide member 10 along the guide axis 22 relative to the guide body 20, balls 73, as in the example depicted, are used as roller bodies for the bearing element 70. Balls 73 have the great advantage of allowing easy axial displaceability of the slide member 10 relative to the guide body 20.

More than one ball is preferably used per bearing element, and the balls are arranged parallel to the guide axis 22. These balls can be mounted in a cage or in a chain (not shown). It has proven advantageous to have two to ten balls per bearing element. In a particularly preferred embodiment, 5 balls are used per bearing element and are held by a chain.

In the embodiment shown, three bearing elements 70, 70′ and 70″ are used in total and are arranged on the outer circumferential region of the slide member 10, at uniform angular intervals of 120° in a plane perpendicular to the guide axis 22.

In this way, a three-point bearing is formed. Besides this group of three bearing elements 70, 70′ and 70″, it is possible to provide further groups of bearing elements (not shown) which are axially offset along the guide axis. These bearing elements can also be configured as plain bearings.

In order to receive a bearing element 70, the slide member 10 is configured with a recess 71 on its jacket surface, which recess 71 serves to partially receive the roller body. In order to receive a ball chain, this recess 71 is elongate and configured with a V-shaped cross section. The longitudinal groove thus formed on the jacket surface of the slide member 10 is configured, in terms of its length, in order to receive a predetermined number of roller bodies or balls.

On account of the V-shaped cross section, the two side faces of the recess run together at an acute angle, which is approximately 90° in the example shown. In this way, the ball 73 can be mounted in a stable manner, wherein only two small contact regions are formed between the ball 73 and the recess 71, and these contact regions cause an only very slight rolling friction during an axial relative movement.

The depth of the recess 71 is adapted to the size of the roller bodies to be received, in this example to the size of the balls 73, in such a way that the inserted balls 73 protrude radially past the jacket surface of the slide member 10, and a contact region 72 with the inner surface 24 of the guide body 20 is thus produced when the slide member 10 is mounted with the bearing elements 70, 70′ and 70″.

During an axial displacement of the slide member 10 relative to the guide body 20, the balls 73 therefore roll, on the one hand, on the side faces of the recess 71 and, on the other hand, on the inner surface 24 of the guide body 20. These surfaces accordingly form the abutment surfaces of the bearing elements 70, 70′ and 70″.

In order to obtain an axial displaceability of slide member 10 and guide body 20 that is free of play if possible, the bearing elements 70, 70′ and 70″ have a slight interference fit for the radial play 18 that is to be bridged.

In this way, a light pressing occurs when the slide member 10 is in contact with the guide body 20.

The interference is therefore to be kept small and is between 0.003 and 0.150 mm, preferably between 0.005 and 0.120 mm. In the example shown, the interference is 0.05 mm.

In this embodiment, lubrication can be dispensed with substantially or completely. A further advantage lies in the very smooth running without rattling. Finally, manufacturing tolerances can also be very easily compensated through the choice of balls of suitable diameter.

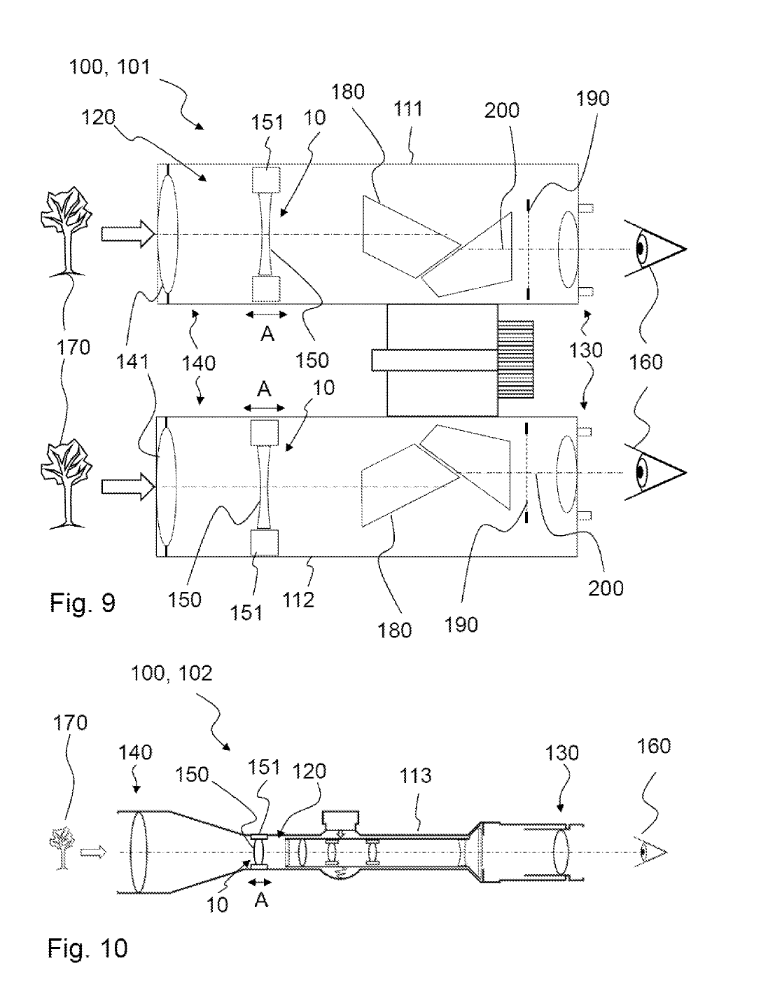

FIG. 9 shows a schematic view of an optical device 100 according to the invention in the form of binoculars 101. FIG. 10 shows a schematic view of an optical device 100 according to the invention in the form of a telescopic sight 102. The optical devices 100, for example the binoculars 101 or the telescopic sight 102, are equipped with a guide system according to the invention, in particular for guiding the linear focusing. Accordingly, they have a guide body 20 and a slide member 10.

Binoculars 101 have two tubes 111, 112 which are arranged parallel to each other and which each contain an optical system 120. A telescopic sight 102 includes one tube 113, which likewise contains an optical system 120.

The optical system 120 designates the entirety of the optical elements of the respective tubes 111, 112, 113 and, in the example of FIG. 9, includes at least one objective 140, an aperture stop, a prism system 108 and an eyepiece 130. An optical axis 200 is respectively defined by the objective 140 and by the eyepiece 130.

The objective can include several individual lenses 141, 150, the focusing of which is served by the guide system, by which an object 170 viewed by a user 160 through the binoculars 101 or through the telescopic sight 102 is focused via the slide member 10 onto the intermediate image plane 190.

The slide member 10 includes a focusing lens 150 with a holder 151 configured as a lens mount. The direction of movement of the slide member 10 in the respective tubes is designated by “A”.

It is understood that the foregoing description is that of the preferred embodiments of the invention and that various changes and modifications may be made thereto without departing from the spirit and scope of the invention as defined in the appended claims.

### LIST OF REFERENCE SIGNS

10 slide member
12 opening
14 optical axis
16 outer surface
18 radial play
20 guide body
22 guide axis
23 tangential direction
24 inner surface
30, 30′ bearing elements
32, 32′ bearing elements
34, 34′ bearing elements
40, 40′ bearing surface
42, 42′ bearing surface
44, 44′ bearing surface
50 abutment surface
52 abutment surface
60 force application site
62 focusing rod
70, 70′, 70″ bearing element
71 recess
72 contact region
73 ball
100 optical device
101 binoculars
102 telescopic sight
111 tube
112 tube
113 tube
120 optical system
130 eyepiece
140 objective
141 lens
150 focusing lens
151 holder
160 user
170 object
180 prism system
190 intermediate image plane
200 optical axis
300 glide component
301 connection component
302 resilient component
303 adhesive component
310 glide component
313 adhesive component

What is claimed is:

1. A guide system comprising:
a guide body defining a guide axis;
a slide member mounted displaceably along said guide axis relative to said guide body;
a bearing element having a bearing surface for the displaceable mounting of said slide member in such a way that said bearing surface comes into gliding contact with an associated abutment surface when said slide member is displaced along said guide axis;
said bearing element being arranged between said slide member and said guide body in such a way that said bearing element reduces a radial play extending radially with respect to the guide axis between said slide member and said guide body; and,
said bearing element having an interference fit for the radial play and a resilience in the radial direction for compensation of the interference fit.

2. The guide system of claim 1, wherein:
said bearing element is secured on said slide member; and,
said guide body includes said abutment surface in such a way that said bearing surface of said bearing element secured on said slide member glides along said abutment surface of said guide body when said slide member is displaced along said guide axis.

3. The guide system of claim 1, wherein:
said bearing element includes a resilient, elastic component in order to provide said resilience of said bearing element;
said bearing element includes a glide component which forms said bearing surface of said bearing element; and,
said glide component of said bearing element has a lower coefficient of friction and a lower compressibility than said resilient component of said bearing element.

4. The guide system of claim 3, wherein said resilient component of said bearing element comprises foam, and/or the glide component of the bearing element includes polytetrafluoroethylene (PTFE).

5. The guide system of claim 1, wherein:
said guide body has an inner surface;
said slide member has an outer surface;
said guide body radially surrounds said slide member in such a way that said inner surface of said guide body is directed toward said outer surface of said slide member;
said bearing element is secured on said outer surface of said slide member; and,
said inner surface of the guide body includes said abutment surface.

6. The guide system of claim 1, wherein:
said slide member defines a circumference; and,
said radial play, extending radially with respect to the guide axis, between said slide member and said guide body extends tangentially over the entirety of said circumference, in such a way that said slide member is spaced apart from said guide element all the way round, radially with respect to said guide axis.

7. The guide system of claim 1, wherein said bearing element extends tangentially to said guide axis at about an angle of less than at least one of 45 degrees, 20 degrees and 10 degrees.

8. The guide system of claim 1, wherein the bearing element is a first bearing element, the guide system further comprising:
a second bearing element;
a third bearing element; and,
said second bearing element and said third bearing element each having a bearing surface for the displaceable mounting of said slide member in such a way that said bearing surfaces of said second bearing element and said third bearing element are each in gliding contact with an associated abutment surface when said slide member is displaced along said guide axis.

9. The guide system of claim 8, wherein:
said second bearing element and said third bearing element are each secured on said slide member; and,
said guide body includes the respective abutment surfaces in such a way that said bearing surfaces of said second bearing element and third bearing element secured on said slide member glide along the respective abutment surfaces of said guide body when said slide member is displaced along said guide axis.

10. The guide system of claim 8, wherein said first bearing element has a greater resilience than at least one of said second bearing element and said third bearing element.

11. The guide system of claim 10, wherein said second bearing element and said third bearing element have substantially no resilience.

12. The guide system of claim 8, wherein said first bearing element, said second bearing element and said third bearing element are spaced apart from each other tangentially to said guide axis and are distributed about a circumference section of over 180 degrees.

13. The guide system of claim 8, wherein said first bearing element, said second bearing element and said third bearing element are spaced apart from each other tangentially to said guide axis and are distributed about a circumference section of over 180 degrees in order to form a three-point bearing.

14. The guide system of claim 8 further comprising:
at least one of one, two and three further bearing elements which are each spaced apart from at least one of said first bearing element, said second bearing element and said third bearing element along the guide axis.

15. The guide system of claim 1, wherein said slide member includes a force application site arranged eccentrically with respect to said guide axis and configured to subject said slide member to a sliding movement.

16. The guide system of claim 15, wherein the bearing element is a first bearing element, the guide system further comprising:
a second bearing element;
a third bearing element; and,
said force application site of said slide member, especially in the tangential direction to the guide axis, being arranged farther from the bearing element than it is from at least one of said second bearing element and said third bearing element.

17. A guide system, in particular for guiding the linear focusing of an optical device, the guide system comprising:
a guide body defining a guide axis;
a slide member mounted displaceably along said guide axis relative to said guide body;
a bearing element including at least one roller bearing with a roller body, in such a way that said roller body is in contact with said slide member and said guide body;
said roller body being configured to roll on said slide member and said guide body when said slide member is displaced along the guide axis; and,
said bearing element being arranged between said slide member and said guide body in such a way that said bearing element reduces a radial play, extending radially with respect to the guide axis, between said slide member and said guide body.

18. The guide system of claim 17, further comprising:
a second bearing element;
a third bearing element; and,
said second bearing element and said third bearing element being arranged in a plane perpendicular to said guide axis and being at an angle distance of 120° from each other.

19. The guide system of claim 17, further comprising at least one ball configured as a roller body.

20. The guide system of claim 17, wherein said bearing element has an interference fit for said radial play.

21. A slide member for a guide system having a guide body defining a guide axis, the slide member comprising:
a slide member body;
a bearing element secured on said slide member body and having a bearing surface for the displaceable mounting of the slide member along a guide axis;
said bearing element including a resilient, elastic component in order to provide a resilience to said bearing element;
said bearing element including a glide component which forms said bearing surface of said bearing element; and,
said glide component of said bearing element having a lower coefficient of friction and a lower compressibility than said resilient component of said bearing element.

22. The slide member of claim 21, wherein said resilient component of said bearing element includes foam and/or said glide component of said bearing element includes polytetrafluoroethylene (PTFE).

23. The slide member of claim 21, wherein the bearing element is a first bearing element, the slide member further comprising:
a second bearing element;
a third bearing element;
said second bearing element and said third bearing element being secured on said slide member and each includes a bearing surface for the displaceable mounting of said slide member along said guide axis; and,
said first bearing element having a greater resilience than at least one of said second bearing element and said third bearing element.

24. The slide member of claim 21, wherein said second bearing element and said third bearing element have substantially no resilience.

25. The slide member of claim 23, wherein said first bearing element, said second bearing element and said third bearing element are secured on said slide member in a manner spaced apart from each other tangentially to said guide axis and are distributed about a circumference section of over 180 degrees.

26. The slide member of claim 23, wherein said first bearing element, said second bearing element and said third bearing element are secured on said slide member in a manner spaced apart from each other tangentially to said guide axis and are distributed about a circumference section of over 180 degrees in order to form a three-point bearing.

27. The slide member of claim 23 further comprising at least one of one, two and three further bearing elements which are each secured on said slide member in a manner spaced apart from at least one of said first bearing element, said second bearing element and said third bearing element along the guide axis.

28. The slide member of claim 231, wherein:
said slide member includes a force application site arranged eccentrically with respect to the guide axis and configured to subject said slide member to a sliding movement; and,
said force application site, especially in the tangential direction to the guide axis, is arranged farther from said first bearing element than it is from at least one of said second bearing element and said third bearing element.

29. A slide member for a guide system having a guide body defining a guide axis, a bearing element including at least one roller bearing with a roller body in such a way that the roller body is in contact with the slide member and the guide body, the roller body being configured to roll on the slide member and said guide body when the slide member is displaced along the guide axis, and the bearing element being arranged between the slide member and the guide body in such a way that the bearing element reduces a radial play, extending radially with respect to the guide axis, between the slide member and the guide body, the slide member comprising:
a slide member body having a jacket surface; and,
said jacket surface having at least one elongate recess which runs parallel to the guide axis and is configured to receive the bearing element.

30. The slide member of claim 29, wherein said slide member has on said jacket surface, in a plane perpendicular to the guide axis, a total of three elongate recesses which run parallel to the guide axis and receive three bearing elements.

31. The slide member of claim 30, wherein the three elongate recesses are arranged at an angle of 120° from each other.

32. The slide member of claim 29, wherein said recess is V-shaped and two associated side faces are arranged at an acute angle of between 70° and 110° or between 80° and 100° or between 85° and 95°.

33. The guide system of claim 1, wherein the guide system is configured to guide a linear focusing of an optical device.

34. An optical device comprising a guide system as claimed in claim 1.

35. The optical device of claim 34, wherein the optical device is a binocular or a telescope sight.

36. The optical device of claim 34 further comprising:
a slide member for the guide system having a bearing element secured on said slide member and having a bearing surface for the displaceable mounting of the slide member along a guide axis;
said bearing element including a resilient, elastic component in order to provide a resilience to said bearing element;
said bearing element including a glide component which forms said bearing surface of said bearing element; and,
said glide component of said bearing element having a lower coefficient of friction and a lower compressibility than said resilient component of said bearing element.

37. An optical device comprising a slide member as claimed in claim 21 wherein the slide member is configured as a lens mount.

38. The optical device of claim 37, wherein the optical device is a binocular or a telescope sight.

39. The optical device of claim 37 further comprising:
a guide system defining a guide axis;
said slide member mounted displaceably along said guide axis relative to said guide system;
a bearing element having a bearing surface for the displaceable mounting of said slide member in such a way that said bearing surface comes into gliding contact with an associated abutment surface when said slide member is displaced along said guide axis;
said bearing element being arranged between said slide member and said guide system in such a way that said bearing element reduces a radial play extending radially with respect to the guide axis between said slide member and said guide body; and,
said bearing element having an interference fit for the radial play and a resilience in the radial direction for compensation of the interference fit.
